(19) United States
(12) Patent Application Publication
(10) Pub. No.: US 2009/0034991 A1
(43) Pub. Date: Feb. 5, 2009

(54) APPARATUS TO PREVENT ERRONEOUS INSERTION OF PARTS, IMAGE FORMING DEVICE HAVING THE SAME, DEVELOPER CARTRIDGE HAVING THE SAME, AND METHOD OF MANUFACTURING THE SAME

(75) Inventor: Jong-pil JUN, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/013,601

(22) Filed: Jan. 14, 2008

(30) Foreign Application Priority Data
Aug. 1, 2007 (KR) 2007-77464

(51) Int. Cl. G03G 15/00

(52) U.S. Cl. 399/12

(57) ABSTRACT

An apparatus to prevent an erroneous insertion of parts in an image forming apparatus, the apparatus includes part placement confirming members provided in a plurality of positions of a plurality of part mounting units, part indication member attachment/detachment units provided in the plurality of parts to be mounted on the part mounting units, and having structures each of which has a plurality of divided sections, and a plurality of part indication members combined into combinations of the respective part indication member attachment/detachment units so as to have corresponding combined structures according to positions of the respective part placement confirming members.

### CROSS-REFERENCE TO RELATED APPLICATIONS

This application claims priority under 35 U.S.C. §119 from Korean Patent Application No. 10-2007-0077464, filed Aug. 1, 2007, in the Korean Intellectual Property Office, the entire disclosure of which is incorporated herein in its entirety by reference.

### BACKGROUND OF THE INVENTION

1. Field of the Invention

The present general inventive concept relates generally to an office automated appliance having a set of a plurality of detachable parts. More particularly, the present general inventive concept relates to an apparatus to prevent an erroneous insertion of parts and an image forming device having an apparatus to prevent an erroneous insertion of developer cartridges, which can prevent the respective parts from being inserted into improper positions.

2. Description of the Related Art

Generally, attempts at common use of parts have been made for improvement of assembling and curtailment of manufacturing cost thereof. Such parts may have the same appearance, but perform different functions. Accordingly, an erroneous insertion of parts into positions that are not their proper insertion positions may occur.

For example, a removable-type developer cartridge of a color image forming device employs a set of developer cartridges for four colors (e.g., yellow, magenta, cyan, and black). These four color developer cartridges can be mounted on the respective proper mounting units provided in the image forming device, respectively.

In general, the developer cartridges for the respective colors are standardized to reduce manufacturing cost, the common use of parts, and so forth. Accordingly, a user may erroneously mount developer cartridges for the respective colors into improper positions. In this case, developers having different characteristics are supplied to the color developing cartridges, and this causes developing inferiority or picture quality inferiority to occur.

In order to prevent an erroneous insertion of color developer cartridges, there is a method for setting an exterior color of the developer cartridge to the same color as the developer stored therein. In this structure, however, there still exists the possibility that a user erroneously mounts a developer cartridge in a wrong position. In addition, this structure requires a separate mold for each color when the developer cartridges are manufactured, thus increasing manufacturing cost. In the case of manufacturing developer cartridges having different colors using one mold, resin can be replaced for each color, and thus the productivity is deteriorated.

Another method for preventing an erroneous insertion of developer cartridges is to provide the color developer cartridges having different shapes. In this case, developer cartridge mounting units of an image forming device should be formed to have shapes corresponding to the different shapes of the color development cartridges to prevent the erroneous mounting of the developer cartridges. In this case, even if the user is careless, the erroneous mounting of the developer cartridges can be prevented. However, since a separate mold is required for each color, the manufacturing cost is increased and the common use of parts becomes impossible.

### SUMMARY OF THE INVENTION

The present general inventive concept provides an apparatus to prevent an erroneous insertion of parts to allow common use of the parts and thus to manufacture the parts with a minimum number of molds.

The present general inventive concept also provides an image forming device having an apparatus to prevent an erroneous insertion of developer cartridges using the apparatus to prevent an erroneous insertion of parts.

The present general inventive concept also provides a developer cartridge having a function of preventing an erroneous insertion thereof that is used in the color image forming device, and a manufacturing method thereof.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an apparatus to prevent an erroneous insertion of parts in an image forming apparatus, the apparatus including part placement confirming members provided in a plurality of positions of a plurality of part mounting units, part indication member attachment/detachment units provided in a plurality of parts to be mounted on the part mounting units, and having structures each of which has a plurality of divided sections, and a plurality of part indication members combined into combinations of the respective part indication member attachment/detachment units so as to have corresponding combined structures according to the positions of the respective part placement confirming members.

The part placement confirming member may include a projection rib formed in a mounting direction of the part, and the plurality of part indication members include pin members coupled to the part indication member attachment/detachment units so as to form rib groove to accommodate the projection rib.

The part mounting units may include first to fourth part mounting units and the part may include first to fourth parts mounted on the respective part mounting units, and wherein first to third projection ribs are arranged in the first to third part mounting units with the respective positions thereof changed at predetermined pitch intervals, the part indication member attachment/detachment unit is divided into first to third sections, the pin members are coupled to the second and third sections of the first part indication member attachment/detachment unit so that the rib groove is formed in the first section among the three sections, the pin members are coupled to the first and third sections of the second part indication member attachment/detachment unit so that the rib groove is formed in the second section among the three sections, and the pin members are coupled to the first and second sections of the third part indication member attachment/detachment unit so that the rib groove is formed in the third section among the three sections.

The part placement confirming member may have groove units formed on one surface of the part mounting unit, and the plurality of part indication members may include pin members coupled to the respective part indication member attachment/detachment units to be accommodated in the groove units.

The part mounting units may include first to fourth part mounting units and the part may include first to fourth parts mounted on the respective part mounting unit, and wherein first to fourth groove units are arranged in the first to fourth part mounting units with the respective positions thereof changed, the part indication member attachment/detachment unit is divided into first to fourth sections, the pin member is coupled to the first section that corresponds to the part placement confirming member of the first part mounting unit among the four sections, the pin member is coupled to the second section that corresponds to the part placement confirming member of the second part mounting unit among the four sections, the pin member is coupled to the third section that corresponds to the part placement confirming member of the third part mounting unit among the four sections, and the pin member is coupled to the fourth section that corresponds to the part placement confirming member of the fourth part mounting unit among the four sections.

The plurality of parts may be developer cartridges for respective colors, and the plurality of part mounting units may be developer cartridge mounting units on which the developer cartridges for the respective colors are mounted.

The plurality of parts may be developing cartridges for respective colors, and the plurality of part mounting units may be developing cartridge mounting units on which the developing cartridges for the respective colors are mounted.

The plurality of parts may be a plurality of waste developer storage units, and the plurality of part mounting units may be a plurality of mounting units for the waste developer storage units on which the plurality of waste developer storage units are mounted.

The plurality of parts may be a plurality of photosensitive units, and the plurality of part mounting units may be a plurality of mounting units for the photosensitive units on which the plurality of photosensitive units are mounted.

The plurality of parts may be a plurality of charging units, and the plurality of part mounting units may be a plurality of mounting units for the charging units on which the plurality of charging units are mounted.

The plurality of parts may be a plurality of cleaning units, and the plurality of part mounting units may be a plurality of mounting units for the cleaning units on which the plurality of cleaning units are mounted.

The foregoing and/or other aspects and utilities of the present general inventive concept may be achieved by providing an image forming device, including an image forming device main body having color developer cartridge mounting units, color developer cartridges mounted on the color developer cartridge mounting units, respectively, and an apparatus to prevent an erroneous insertion of the developer cartridges, the apparatus includes part placement confirming members provided in a plurality of positions of the color developer cartridge mounting units, color indication member attachment/detachment units provided in the plurality of color developer cartridges and having structures each of which has a plurality of divided sections, and a plurality of color indication members combined into combinations of the respective color indication member attachment/detachment units so as to have corresponding combined structures according to the positions of the respective part placement confirming members.

The part placement confirming member may be a projection rib formed in a mounting direction of the developer cartridge, and the plurality of color indication members may include pin members coupled to the color indication member attachment/detachment units so as to form rib grooves to accommodate the projection rib.

The color developer cartridge mounting units may include first to fourth color developer cartridge mounting units and the color developer cartridges may include first to fourth color developer cartridges mounted on the respective color developer cartridge mounting units, and wherein first to third projection ribs are arranged in the first to third color developer cartridge mounting units with the respective positions thereof changed at predetermined pitch intervals, the color indication member attachment/detachment unit is divided into first to third sections, the pin members are coupled to the second and third sections of the color indication member attachment/detachment unit of the first color developer cartridge so that the rib groove is formed in the first section among the three sections, the pin members are coupled to the first and third sections of the color indication member attachment/detachment unit of the second color developer cartridge so that the rib groove is formed in the second section among the three sections, and the pin members are coupled to the first and second sections of the color indication member attachment/detachment unit of the third color developer cartridge so that the rib groove is formed in the third section among the three sections.

The part placement confirming member may have groove units formed on one surface of the developer cartridge mounting unit, and the plurality of color indication members may include pin members coupled to the respective color indication member attachment/detachment units to be accommodated in the groove units.

The color developer cartridge mounting units may include first to fourth color developer cartridge mounting units and the color developer cartridges may include first to fourth color developer cartridges mounted on the respective color developer cartridge mounting unit, and wherein first to fourth groove units are arranged in the first to fourth developer cartridge mounting units with the respective positions thereof changed, the color indication member attachment/detachment unit is divided into first to fourth sections, the pin member is coupled to the first section that corresponds to the groove unit of the first developer cartridge mounting unit among the four sections in the color indication member attachment/detachment unit of the first color developer cartridge, the pin member is coupled to the second section that corresponds to the groove unit of the second developer cartridge mounting unit among the four sections in the color indication member attachment/detachment unit of the second color developer cartridge, the pin member is coupled to the third section that corresponds to the groove unit of the third developer cartridge mounting unit among the four sections in the color indication member attachment/detachment unit of the third developer cartridge, and the pin member is coupled to the fourth section that corresponds to the groove unit of the fourth developer cartridge mounting unit among the four sections in the color indication member attachment/detachment unit of the fourth developer cartridge.

The foregoing and/or other aspects and utilities of the present general inventive concept may also be achieved by providing an image forming device, including a plurality of color developer cartridge mounting units provided in an image forming device main body, a plurality of color developer cartridges mounted on the plurality of color developer cartridge mounting units, respectively, first to third part placement confirming members provided in a plurality of positions of the plurality of color developer cartridge mounting units, and first to third color indication units provided in the plurality of color developer cartridges.

The first to third color indication units may include color indication member attachment/detachment units provided in corresponding positions of the part placement confirming members of the color developer cartridges and having structures each of which has a plurality of divided sections having a specific pitch, and a plurality of color indication members combined into specific combinations with the respective color indication member attachment/detachment units so that the respective color indication member attachment/detachment units have corresponding combined structures according to the positions of the first to third part placement confirming members.

The foregoing and/or other aspects and utilities of the present general inventive concept may also be achieved by providing a developer cartridge mounted on a developer cartridge mounting unit provided in an image forming device, the developer cartridge including a developer of a specific color, a color indication unit provided outside the developer cartridge to prevent an erroneous insertion of parts and corresponding to a part placement confirming member provided in one of a plurality of positions in the developer cartridge mounting unit, and the color indication unit including a color indication member attachment/detachment unit having a structure composed of a plurality of divided sections and a plurality of color indication members combined into a specific combination with the color indication member attachment/detachment unit so as to have a corresponding combined structure according to the position of the part placement confirming member.

The plurality of sections of the color indication member attachment/detachment unit may have a specific pitch. The color indication members may include pin members detachably attached to the color indication member attachment/detachment unit.

The foregoing and/or other aspects and utilities of the present general inventive concept may also be achieved by providing a method of manufacturing a developer cartridge, including forming a developer cartridge housing having color indication member attachment/detachment units each of which has a structure divided into a plurality of sections, filling developers of different colors in the developer cartridge housing and sealing the housing, and forming color indication units to prevent an erroneous insertion of parts by making color indication members combined into specific combinations with the plurality of sections of the color indication member attachment/detachment units provided in the developer cartridge housing so that the respective color indication member attachment/detachment units have corresponding combined structures with part placement confirming members provided in a plurality of positions.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a schematic view illustrating an apparatus to prevent an erroneous insertion of parts and an apparatus to prevent an erroneous insertion of developer cartridges of an image forming device using the apparatus according to an embodiment of the present general inventive concept;

FIGS. 2A and 2B are views illustrating in detail a structure of part placement confirming members and part indication units (or color indication units) that are main parts of the apparatus of FIG. 1;

FIG. 3A is a perspective view illustrating a set of developer cartridges mounted on developer cartridge mounting units according to an embodiment of the present general inventive concept;

FIG. 3B is a partially cut-away expanded view of FIG. 3A;

FIG. 4 is a schematic view illustrating prevention of an erroneous insertion of parts that is applied to developer cartridges according to another embodiment of the present general inventive concept; and

FIG. 5 is a sectional view schematically illustrating an image forming device adopting an apparatus to prevent an erroneous insertion of parts according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

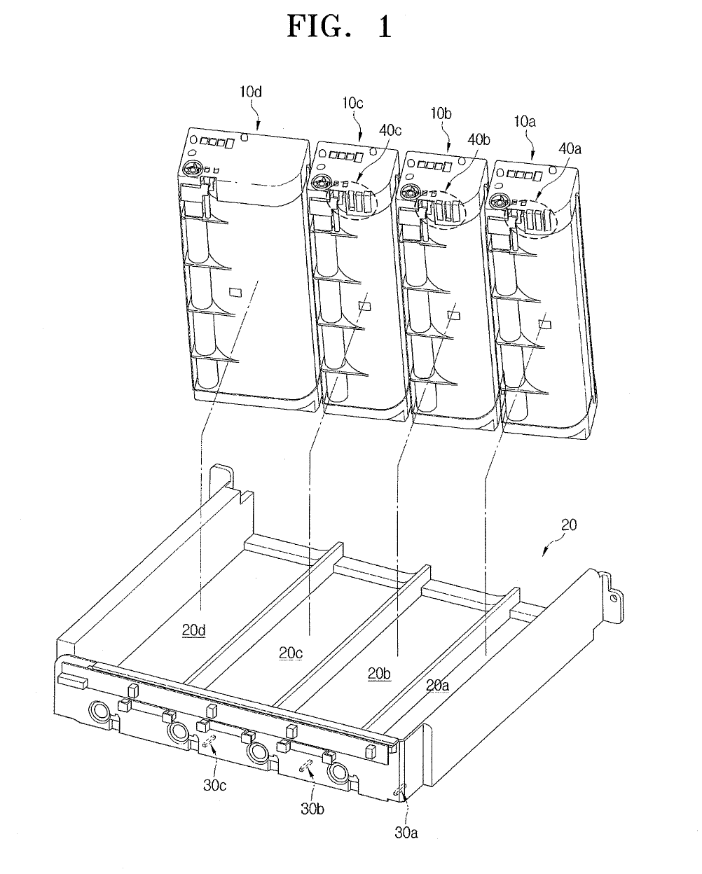

FIG. 1 is a schematic view illustrating an apparatus to prevent an erroneous insertion of parts and an apparatus to prevent an erroneous insertion of developer cartridges of an image forming device using the apparatus according to an embodiment of the present general inventive concept.

Parts described in claims may be a plurality of developer cartridges for respective colors, and part mounting units may be a plurality of color developer cartridge mounting units provided in a main body of an image forming device. Part mounting units may be a plurality of color developer cartridge mounting units provided in the main body of the image forming device. Also, an apparatus to prevent an erroneous insertion of parts may be applied to an apparatus to prevent an erroneous insertion of developing cartridges, and in this case, the part mounting unit may be a developer cartridge mounting unit. In addition, the apparatus to prevent an erroneous insertion of parts according to an embodiment of the present general inventive concept may be usefully applied to various systems including office automated appliances in which respective parts should be mounted on the respective predetermined positions thereof.

In FIG. 1, reference numerals 10a to 10d denote color developer cartridges, and 20a to 20d denote color developer cartridge mounting units provided in a main body 20 of the image forming device. Also, 30a to 30c denote part placement confirming members provided in the color developer cartridge mounting units 20a to 20c, and 40a to 40c denote color indication units provided in the color developer cartridges 10a to 10c.

In the color developer cartridges 10a to 10d, different developers are filled. That is, yellow, magenta, cyan, and black developers are stored in the developer cartridges 10a to 10d, respectively. These developer cartridges 10a to 10d have the same or similar external appearance except for the black developer cartridge 10d. Generally, since an amount of black developer used is larger than that of other developers, the size of the black developer cartridge is larger than other color cartridges.

Since the black developer cartridge 10d has a size larger than the other color developer cartridges, an erroneous insertion of the black developer cartridge may not occur. However, other developer cartridges 10a to 10c except for the black developer cartridge have the same or similar shape, and may be erroneously mounted on the respective developer cartridge mounting units. If the color developer cartridges 10a to 10d are not properly mounted on the corresponding developer cartridges 20a to 20d, respectively, the developing inferiority or picture quality inferiority occurs as described above. Hereinafter, the apparatus to prevent the erroneous insertion of the developer cartridges will be described.

The plurality of part placement confirming members 30a to 30c and color indication units 40a to 40c constitute the apparatus to prevent the erroneous insertion of the developer cartridges. The part placement confirming members 30a to 30c are arranged in different positions on bottom portions of lower surfaces of the developer cartridge mounting units 20a to 20c. The color indication units 40a to 40c are provided on color developer cartridges 10a to 10c and arranged in positions to correspond to the part placement confirming members 30a to 30c.

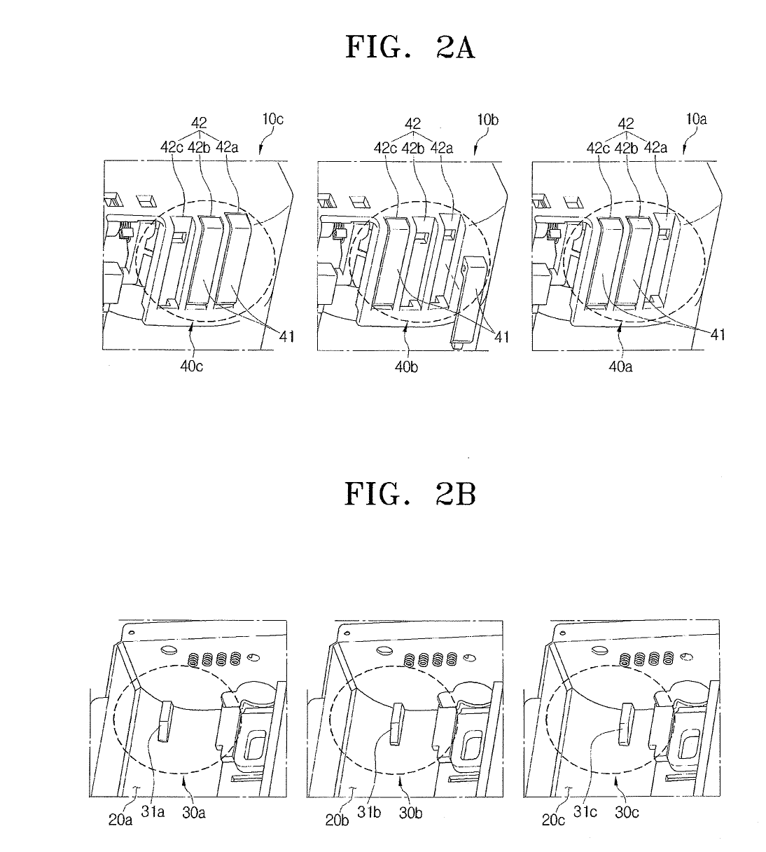

The part placement confirming members 30a to 30c are arranged on the respective developer cartridge mounting units with the respective positions thereof changed at an interval of a pitch under an assumption that a thickness of the part safe displacement confirming member is set to one pitch. The part safe displacement confirming members 30a to 30c, as illustrated in FIG. 2B, may be formed in the mounting direction of the developer cartridges in a form of a projection rib 31.

The color indication units 40a to 40c, as illustrated in FIG. 2A, include a plurality of color indication members 41 and color indication member attachment/detachment units 42. The color indication member attachment/detachment unit 42 is divided into a plurality of sections 42a, 42b, and 42c having a specific pitch. The sections 42a, 42b, and 42c may be formed as grooves having a predetermined length and width. The color indication member attachment/detachment units 42 are formed on the three developer cartridges 10a to 10c with the same structure. The color indication members 41 may be formed as pin members detachably attached to the color indication member attachment/detachment units 42.

The three sections 42a, 42b, and 42c are selectively closed by the plurality color indication members 41, so that only one of the sections remains open as a groove spaced apart from a reference by a corresponding distance. For example, in the first developer cartridge 10a, the second and third sections 42b and 42c among three sections 42a, 42b, and 42c of the color indication member attachment/detachment unit 42 are coupled to the color indication members 41, and the first section 42a remains open as the groove. In the second developer cartridge 10b, the first and third sections 42a and 42c are coupled to the color indication members 41, and the second section 42b remains open as the groove. Also, in the third developer cartridge 10c, the first and second sections 42a and 42b are coupled to the color indication members 41, and the third section 42c remains open as the groove. The portions remaining as the grooves of the respective developer cartridges 10a to 10c form corresponding combined structures with the developer cartridge mounting units 20a to 20c according to positions of the part placement confirming members 30a to 30c.

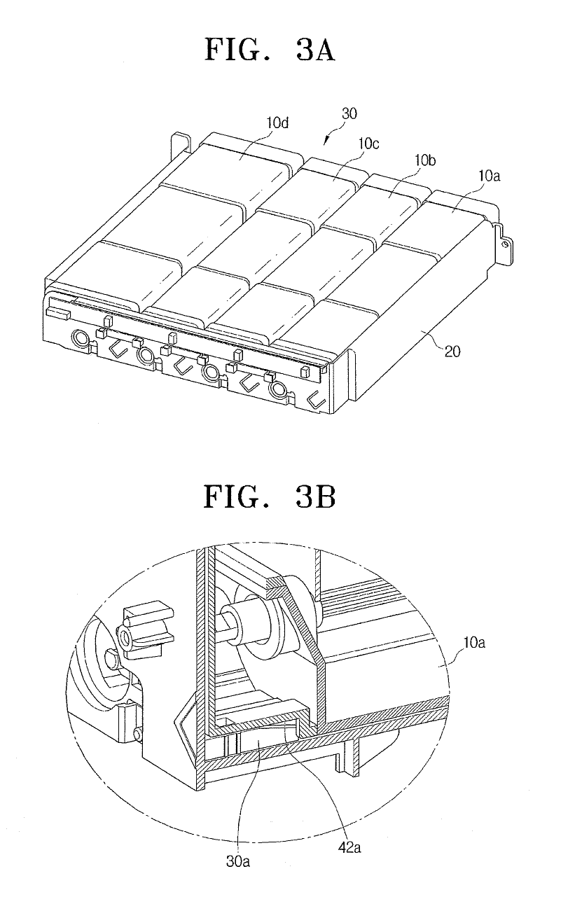

For example, as illustrated in FIGS. 2A to 3B, if the first developer cartridge 10a is mounted on the first developer cartridge mounting unit 20a (FIG. 2B), a projection rib 31a of the developer cartridge mounting unit 20a accurately coincides with the first section 42a of the open groove structure formed on the color indication member attachment/detachment unit 42 of the developer cartridge 10a. Thus, the developer cartridge 10a is mounted on the developer cartridge mounting unit 20a without erroneous insertion.

The projection rib 31a is spaced apart from the reference by the corresponding distance, so that the projection rib 31a is inserted into the corresponding groove, that is, the one of the sections of 42a, 42b, and 42c. If the projection rib 31a does not match the corresponding groove, that is, the projector rib 31a is not properly inserted into the corresponding groove, the developer cartridge 10a, 10b, 10c or 10d is not properly mounted into the main body 10.

However, if the first developer cartridge 10a is mounted on the second developer cartridge mounting unit 20b, a projection rib 31b of the developer cartridge mounting unit 20b does not coincide with the first section 42a of the open groove structure formed on the color indication member attachment/detachment unit 42 of the developer cartridge 10a. Thus, the developer cartridge 10a is not mounted on the developer cartridge mounting unit 20b even if a user pushes the developer cartridge 10a toward the developer cartridge mounting unit 20b. In the same manner, the first developer cartridge 10a cannot be mounted on the third developer cartridge mounting unit 20c since a projection rib 31c of the third developer cartridge mounting unit 20c does not coincide with the first section 42a of the open groove structure formed on the color indication member attachment/detachment unit 42 of the first developer cartridge 10a.

In the same manner, the second developer cartridge 10b can be mounted only on the second developer cartridge mounting unit 20b, and the third developer cartridge 10c can be mounted only on the third developer cartridge mounting unit 20c. In the above-described process, the user can easily confirm that the present developer cartridge is not in the proper position by confirming that the developer cartridge is not mounted on the developer cartridge mounting unit. Accordingly, the developer cartridges 10a to 10c can be prevented from being mounted in improper positions.

The combination of the color indication member 41 with the color indication member attachment/detachment unit 42 is not limited to that of the above-described embodiment of the present general inventive concept. Under an assumption that a specific developer cartridge can be mounted only on a specific developer cartridge mounting unit, such a combination may be modified in a diverse manner.

In the embodiment of the present general inventive concept as described above, an external appearance of the black developer cartridge 10d is different from the other developer cartridges 10a to 10c. However, even in the case where the external appearance of the black developer cartridge is the same as that of the other developer cartridges, the present general inventive concept can be applied thereto. In this case, a new combination coupling the color indication member 41 to the color indication member attachment/detachment unit 42 can be added, or to add another divided section to the color indication member attachment/detachment unit 42.

Alternatively, a method of manufacturing developer cartridges 10a to 10d will now be described.

First, a plurality of developer cartridge housings having color indication member attachment/detachment units each of which has the same structure divided into a plurality of sections having a specific pitch is formed. In this case, the housing has the same external structure and can be formed using one mold. Specifically, in the case of the developer cartridge having a general apparatus to prevent an erroneous insertion of parts, projections to prevent an erroneous insertion of parts having different positions are formed integrally on the respective developer cartridge housings. Thus, the housings are formed using at least three molds. In the present general inventive concept, however, any other structure to prevent the erroneous insertion of parts is not yet applied when the housing is molded. Thus, the housing having the same external appearance can be formed using only one mold. In an embodiment, for example, the color indication unit 40a, 40b and 40c is selectively changeable to conform to and engage the arrangement of the one or more part placement confirming members 30a, 30b and 30c of a respective one of the color developer cartridge mounting units 20a, 20b and 20c.

As described above, after a plurality of housings having the same structure are formed, different developers are filled in the respective housings and then the housings are sealed.

Thereafter, color indication units are formed on the color indication member attachment/detachment units provided in the plurality of developer cartridge housings through diverse combinations with a plurality of color indication members. That is, as described above, the structure to prevent an erroneous insertion of developer cartridges are is formed by selectively combining the color indication members with a plurality of sections of the color indication member attachment/detachment units provided in the respective developer cartridges, so that the respective developer cartridge has a corresponding combined structure according to different positions of the different part placement confirming members provided in the developer cartridge mounting units.

As described above, when the developer cartridges are manufactured, a plurality of housings having the same external appearance are formed using one mold, and then a structure to prevent an erroneous insertion of developer cartridges is formed. Accordingly, the common use of parts becomes possible. Thus, the parts can be manufactured with a minimum number of molds.

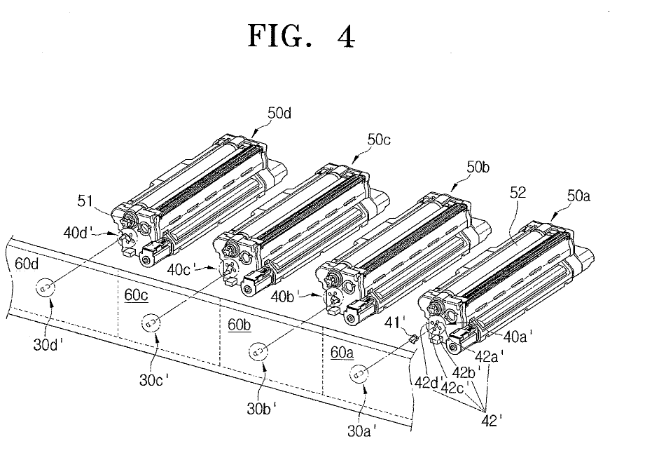

FIG. 4 is a schematic view illustrating prevention of an erroneous insertion of parts that is applied to developing cartridges according to another embodiment of the present general inventive concept.

In FIG. 4, reference numerals 50a to 50d denote developing cartridges, and 60a to 60d denote developing cartridge mounting units provided in the main body of the image forming device. Also, 30a′ to 30d′ denote part placement confirming members provided in the color developing cartridge mounting units, and 40a′ to 40d′ denote color indication units provided in the developing cartridges.

To the developing cartridges 50a to 50d, yellow, magenta, cyan, and black developers, which are stored in the developer cartridges 10a to 10d, are supplied. A shutter 51 controls such supply of the developers. The developing cartridges 50a to 50d develop an electrostatic latent image with the supplied developers. Since the developing cartridges 50a to 50d are the same as the existing developing cartridges, the detailed description thereof will be omitted.

The plurality of part placement confirming members 30a′ to 30d′ and color indication units 40a′ to 40d′ constitute the apparatus to prevent the erroneous insertion of the developing cartridges. The part placement confirming members 30a′ to 30d′ are arranged in different positions on surfaces of the developing cartridge mounting units 60a to 60d to be spaced apart from a reference by a corresponding distance. The color indication units 40a′ to 40d′ are provided on the developing cartridges 50a to 50d and arranged at positions to correspond to the part placement confirming members 30a′ to 30d′.

The plurality of part placement confirming members 30a′ to 30d′, as illustrated in FIG. 4, may be formed as grooves to accommodate the color indication members 41′.

The color indication units 40a′ to 40d′ include a plurality of color indication members 41′ and color indication member attachment/detachment units 42′. The color indication member attachment/detachment unit 42′ is divided into four sections 42a′ to 42d′ having different positions. The sections 42a′ to 42d′ may be formed as grooves having a predetermined length and width. The color indication member attachment/detachment units 42′ are formed on the four developing cartridges 50a to 50d with the same structure. The color indication members 41′ may be formed as pin members.

The color indication members 41′ may be selectively coupled to the four sections 42a′ to 42d′. For example, in the first developing cartridge 50a, the first section 42a′ among the four sections 42a′ to 42d′ of the color indication member attachment/detachment unit 42′ is coupled to the color indication member 41′, and in the second developing cartridge 50b, the second section 42b′ is coupled to the color indication member 41′. Also, in the third developing cartridge 50c, the third section 42c′ is coupled to the color indication member 41′, and in the fourth developing cartridge 50d, the fourth section 42d′ is coupled to the color indication member 41′. The portions coupled to the color indication members 41′ form corresponding combined structures with the developing cartridge mounting units 60a to 60d according to different positions of the part placement confirming members 30a′ to 30d′.

For example, as illustrated in FIG. 4, if the first developing cartridge 50a is mounted on the first developing cartridge mounting unit 60a, the part placement confirming member 30a′ of the developing cartridge mounting unit 60a accurately corresponds with the color indication member 41′ coupled to the color indication member attachment/detachment unit 42a′ of the developing cartridge 50a. Thus, the developing cartridge 50a can be mounted on the developing cartridge mounting unit 60a.

However, if the first developing cartridge 50a is mounted on the second developing cartridge mounting unit 60b, the part placement confirming member 30b′ of the developing cartridge mounting unit 60b does not correspond with the color indication member 41′ coupled to the color indication member attachment/detachment unit 42a′ of the developing cartridge 50a. Thus, the developing cartridge 50a can not be mounted on the developing cartridge mounting unit 60b. That is, the first developing cartridge 50a can be mounted only on the first developing cartridge mounting unit 60a, and the second developing cartridge 50b can be mounted only on the second developing cartridge mounting unit 60b. The third developing cartridge 50c can be mounted only on the third developing cartridge mounting unit 60c, and the fourth developing cartridge 50d can be mounted only on the fourth developing cartridge mounting unit 60d. In the above-described process, the user can easily confirm that the present developing cartridge is not in the proper position by confirming that the developing cartridge is not mounted on the developing cartridge mounting unit. Accordingly, the developing cartridges 50a to 50d can be prevented from being mounted on improper positions.

The combination of the color indication member 41′ with the color indication member attachment/detachment unit 42′ is not limited to that of the above-described embodiment of the present general inventive concept. Under an assumption that a specific developing cartridge can be mounted only on a specific developing cartridge mounting unit, such a combination may be modified in a diverse manner. Also, a structure of the part placement confirming member can be diversely modified. In addition, the apparatus to prevent an erroneous insertion of parts applied to the developer cartridges can be applied to the developing cartridges, and vice versa.

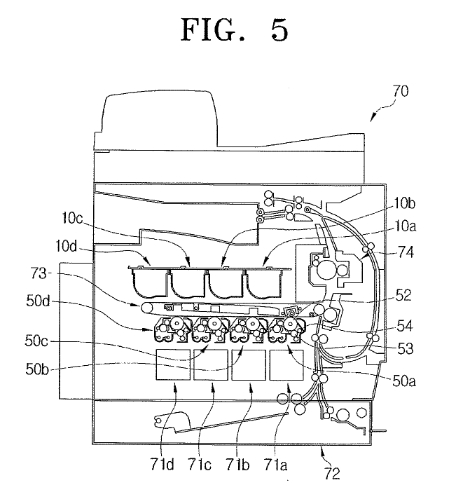

FIG. 5 is a sectional view schematically illustrating an image forming device 70 adopting an apparatus to prevent an erroneous insertion of parts according to an embodiment of the present general inventive concept.

Color developer cartridges 10a to 10d are provided in an image forming device 70 to store color developers. In the embodiment of the present general inventive concept, the black developer cartridge 10d has the same external appearance as that of other developer cartridges 10a to 10c. Color developing cartridges 50a to 50d are provided below the developer cartridges 10a to 10d, and receive the developers from the color developer cartridges 10a to 10d, respectively.

The respective developing cartridge includes a photosensitive unit 52, a charging unit 53, and a cleaning unit 54. An electrostatic latent image is formed on the photosensitive unit 52, and then is developed into a visual image by the developers. The charging unit 53 charges the photosensitive unit 52 with a specific electric potential. The cleaning unit 54 removes the remaining developers on the photosensitive unit 52 after the transfer process. The removed developers are stored in waste developer storage units 71a to 71d provided below the developing cartridges.

A feed unit 72 stores printing medium on which an image is formed. The developer image developed by the developing cartridges 50a to 50d is transferred to the print medium by a transfer unit 73. When the print medium passes through a fusing unit 74, the developer image is fused, and then the print medium is discharged to an outside to complete the printing.

When the developer cartridges or developing cartridges are separated and then mounted again, or replaced by new cartridges for repair and maintenance, the parts can be mounted in proper positions by the apparatus to prevent an erroneous insertion of part according to an embodiment of the present general inventive concept.

In the embodiment of the present general inventive concept, the structure to prevent an erroneous insertion of parts is applied to developer cartridges and developing cartridges. However, the structure is not applicable only to the developer cartridges. For example, the structure to prevent the erroneous insertion of the parts can also be applied to structures in that a plurality of units having the same or similar shapes as serving to perform the same or similar functions are detachably attached, such as a plurality of detachable waste developer storage units to store waste developers, a plurality of photosensitive units detachably coupled to the developer cartridges, a plurality of charging units detachably coupled to the developer cartridges, a plurality of cleaning units detachably coupled to the developer cartridges to clean the charging medium or photosensitive medium, and so forth.

Also, in an embodiment of the present general inventive concept, the color indication member attachment/detachment units are divided into three or four sections 42a to 42c or 42a′ to 42d′. However, a diverse number of sections can be used according to a number of types of parts.

In addition, various embodiments of the present general inventive concept, pin members are used as color indication members 41. However, it will be apparent to those skilled in the art that color indication members having diverse structures detachably attached to color indication member attachment/detachment units 42.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An apparatus to prevent an erroneous insertion of parts in an image forming apparatus, the apparatus comprising:
part placement confirming members provided in a plurality of positions of a plurality of part mounting units;
part indication member attachment/detachment units provided in a plurality of parts to be mounted on the part mounting units, and having structures each of which has a plurality of divided sections; and
a plurality of part indication members combined into combinations of the respective part indication member attachment/detachment units so as to have corresponding combined structures according to the positions of the respective part placement confirming members.

2. The apparatus of claim 1, wherein:
the part placement confirming member comprises a projection rib formed in a mounting direction of the part; and
the plurality of part indication members comprise pin members coupled to the part indication member attachment/detachment units so as to form rib grooves to accommodate the projection rib.

3. The apparatus of claim 2, wherein:
the part mounting units comprise first to fourth part mounting units; and
the parts comprise first to fourth parts mounted on the respective part mounting units, and
wherein first to third projection ribs are arranged in the first to third part mounting units with the respective positions thereof changed at predetermined pitch intervals; the part indication member attachment/detachment unit is divided into first to third sections; the pin members are coupled to the second and third sections of the first part indication member attachment/detachment unit so that the rib groove is formed in the first section among the three sections; the pin members are coupled to the first and third sections of the second part indication member attachment/detachment unit so that the rib groove is formed in the second section among the three sections; and the pin members are coupled to the first and second sections of the third part indication member attachment/detachment unit so that the rib groove is formed in the third section among the three sections.

4. The apparatus of claim 1, wherein:
the part placement confirming member comprises groove units formed on one surface of the part mounting unit; and
the plurality of part indication members comprise pin members coupled to the respective part indication member attachment/detachment units to be accommodated in the groove units.

5. The apparatus of claim 4, wherein:
the part mounting units comprise first to fourth part mounting units; and
the parts comprise first to fourth parts mounted on the respective part mounting unit, and
wherein first to fourth groove units are arranged in the first to fourth part mounting units with the respective positions thereof changed; the part indication member attachment/detachment unit is divided into first to fourth sections; the pin member is coupled to the first section that corresponds to the part placement confirming member of the first part mounting unit among the four sections; the pin member is coupled to the second section that corresponds to the part placement confirming member of the second part mounting unit among the four sections; the pin member is coupled to the third section that corresponds to the part placement confirming member of the third part mounting unit among the four sections; and the pin member is coupled to the fourth section that corresponds to the part placement confirming member of the fourth part mounting unit among the four sections.

6. The apparatus of claim 1, wherein:
the plurality of parts are developer cartridges for respective colors; and
the plurality of part mounting units are developer cartridge mounting units on which the developer cartridges for the respective colors are mounted.

7. The apparatus of claim 1, wherein:
the plurality of parts are developing cartridges for respective colors; and
the plurality of part mounting units are developing cartridge mounting units on which the developing cartridges for the respective colors are mounted.

8. The apparatus of claim 1, wherein the plurality of parts are a plurality of waste developer storage units, and the plurality of part mounting units are a plurality of mounting units for the waste developer storage units on which the plurality of waste developer storage units are mounted.

9. The apparatus of claim 1, wherein:
the plurality of parts are a plurality of photosensitive units; and
the plurality of part mounting units are a plurality of mounting units for the photosensitive units on which the plurality of photosensitive units are mounted.

10. The apparatus of claim 1, wherein:
the plurality of parts are a plurality of charging units; and
the plurality of part mounting units are a plurality of mounting units for the charging units on which the plurality of charging units are mounted.

11. The apparatus of claim 1, wherein:
the plurality of parts are a plurality of cleaning units; and
the plurality of part mounting units are a plurality of mounting units for the cleaning units on which the plurality of cleaning units are mounted.

12. An image forming device, comprising:
an image forming device main body having color developer cartridge mounting units;
color developer cartridges mounted on the color developer cartridge mounting units, respectively; and
an apparatus to prevent an erroneous insertion of the developer cartridges, the apparatus comprises:
part placement confirming members provided in different positions of the color developer cartridge mounting units;
color indication member attachment/detachment units provided in the plurality of color developer cartridges and having structures each of which has a plurality of divided sections; and
a plurality of color indication members combined into combinations of the respective color indication member attachment/detachment units so as to have corresponding combined structures according to positions of the respective part placement confirming members.

13. The image forming device of claim 12, wherein:
the part placement confirming member comprises a projection rib formed in a mounting direction of the developer cartridge; and
the plurality of color indication members comprise pin members coupled to the color indication member attachment/detachment units so as to form rib grooves to accommodate the projection rib.

14. The image forming device of claim 13, wherein:
the mounting units for the color developer cartridges comprise first to fourth color developer cartridge mounting units; and
the color developer cartridges comprise first to fourth color developer cartridges mounted on the respective color developer cartridge mounting units, and
wherein first to third projection ribs are arranged in the first to third color developer cartridge mounting units with the respective positions thereof changed at predetermined pitch intervals; the color indication member attachment/detachment unit is divided into first to third sections; the pin members are coupled to the second and third sections of the color indication member attachment/detachment unit of the first color developer cartridge so that the rib groove is formed in the first section among the three sections; the pin members are coupled to the first and third sections of the color indication member attachment/detachment unit of the second color developer cartridge so that the rib groove is formed in the second section among the three sections; and the pin members are coupled to the first and second sections of the color indication member attachment/detachment unit of the third color developer cartridge so that the rib groove is formed in the third section among the three sections.

15. The image forming device of claim 12, wherein:
the part placement confirming member comprises groove units formed on one surface of the developer cartridge mounting unit; and
the plurality of color indication members comprises pin members coupled to the respective color indication member attachment/detachment units to be accommodated in the groove units.

16. The image forming device of claim 15, wherein:
the mounting units for the color developer cartridges comprise first to fourth color developer cartridge mounting units; and
the color developer cartridges comprise first to fourth color developer cartridges mounted on the respective color developer cartridge mounting unit, and
wherein first to fourth groove units are arranged in the first to fourth developer cartridge mounting units with the respective positions thereof changed; the color indication member attachment/detachment unit is divided into first to fourth sections; the pin member is coupled to the first section that corresponds to the groove unit of the first developer cartridge mounting unit among the four sections in the color indication member attachment/detachment unit of the first color developer cartridge; the pin member is coupled to the second section that corresponds to the groove unit of the second developer cartridge mounting unit among the four sections in the color indication member attachment/detachment unit of the second color developer cartridge; the pin member is coupled to the third section that corresponds to the groove unit of the third developer cartridge mounting unit among the four sections in the color indication member attachment/detachment unit of the third developer cartridge; and the pin member is coupled to the fourth section that corresponds to the groove unit of the fourth developer cartridge mounting unit among the four sections in the color indication member attachment/detachment unit of the fourth developer cartridge.

17. An image forming device, comprising:
a plurality of color developer cartridge mounting units provided in an image forming device main body;
a plurality of color developer cartridges mounted on the plurality of color developer cartridge mounting units, respectively;
first to third part placement confirming members provided in a plurality of positions of the plurality of color developer cartridge mounting units; and
first to third color indication units provided in the plurality of color developer cartridges;
wherein the first to third color indication units comprise:
color indication member attachment/detachment units provided in corresponding positions of the part placement confirming members of the color developer cartridges and having structures each of which has a plurality of divided sections having a specific pitch; and
a plurality of color indication members combined into specific combinations with the respective color indication member attachment/detachment units so that the respective color indication member attachment/detachment units have corresponding combined structures according to the positions of the first to third part placement confirming members.

18. The image forming device of claim 17, wherein:
the part placement confirming member comprises a projection rib formed in a mounting direction of the developer cartridge; and the plurality of color indication members comprise pin members coupled to the color indication member attachment/detachment units so as to form rib grooves to accommodate the projection rib.

19. The image forming device of claim 17, wherein:
the part placement confirming member comprises groove units formed on one surface of the developer cartridge mounting unit; and
the plurality of color indication members comprise pin members coupled to the color indication member attachment/detachment units to be accommodated in the groove units.

20. A developer cartridge mounted on a developer cartridge mounting unit provided in an image forming device, the developer cartridge comprising:
a developer of a specific color;
a color indication unit provided outside the developer cartridge to prevent an erroneous insertion of parts and corresponding to a part placement confirming member provided in one of a plurality of positions in the developer cartridge mounting unit, the color indication unit comprising:
a color indication member attachment/detachment unit having a structure composed of a plurality of divided sections and a plurality of color indication members combined into a specific combination with the color indication member attachment/detachment unit so as to have a corresponding combined structure according to the position of the part placement confirming member.

21. The developer cartridge of claim 20, wherein the plurality of sections of the color indication member attachment/detachment unit have a specific pitch.

22. The developer cartridge of claim 20, wherein the color indication members comprise:
pin members detachably attached to the color indication member attachment/detachment unit.

23. A method of manufacturing a developer cartridge, the method comprising:
forming a developer cartridge housing having color indication member attachment/detachment units each of which has a structure divided into a plurality of sections;
filling developers of different colors in the developer cartridge housing and sealing the housing; and
forming color indication units to prevent an erroneous insertion of parts by making color indication members combined into specific combinations with the plurality of sections of the color indication member attachment/detachment units provided in the developer cartridge housing so that the respective color indication member attachment/detachment units have corresponding combined structures with part placement confirming members provided in a plurality of positions.

24. The method of claim 23, wherein the color indication members comprise:
pin members detachably attached to the color indication member attachment/detachment units.
